(19) United States
(12) Patent Application Publication
(10) Pub. No.: US 2002/0172159 A1
(43) Pub. Date: Nov. 21, 2002

(54) Receiver-end supplementary circuit for boundary scan in data transmission with differential signals

(76) Inventors: Wilhelm Koenig, Stadtbergen (DE); Gerhard Zettl, Kirchheim (DE)

Correspondence Address: Kevin R. Spivak, Morrison & Foerster LLP, Suite 5500, 2000 Pennsylvania Avenue, N.W., Washington, DC, 20006-1888, US

(21) Appl. No.: 10/083,653

(22) Filed: Feb. 27, 2002

(30) Foreign Application Priority Data
Feb. 28, 2001 (DE) 10109558.9

(51) Int. Cl. H04J 1/16

(52) U.S. Cl. 370/241

(57) ABSTRACT

An input circuit which in the course of a boundary scan test makes an interruption in one or both signal feeds clearly detectable is proposed for integrated circuits with differential data inputs.

### CLAIM FOR PRIORITY

This application claims priority to Application No. DE 10109558.9 which was published in the German language on Feb. 28, 2001.

### TECHNICAL FIELD OF THE INVENTION

The invention relates to an input circuit and method for the detection of an interruption in a differential signal feed.

### BACKGROUND OF THE INVENTION

For testing the soldered connections between various devices ICs (integrated circuits) on assemblies, a boundary scan operation is generally used. Boundary scan (BSc) is a test logic which is integrated in the device and serves as a test aid for device and assembly testing. Boundary scan has been standardized by IEEE /1/: “IEEE Standard Test Access Port and Boundary-Scan Architecture, IEEE Std 1149.1-1990 (includes IEEE Std 1149.1a-1993), of Oct. 21, 1993, published by the IEEE Institute of Electrical and Electronics Engineers, Inc., New York”. The BSc architecture comprises a shift register (BSc register), which is inserted between terminal pins and internal logic in such a way that in normal operation the signal is passed through an additional multiplexer.

FIG. 1 shows the boundary scan principle and the application when testing connection lines on an assembly. The boundary scan input cells BScIN are located between the input pins E1 to En and the core logic CL (for: Core Logic) of a device IC1 (for: Integrated Circuit) and the boundary scan output cells BScOUT are located between the core logic and the output pins A1.1 to An. The BSc cells BScIN and BScOUT form the individual memory cells of the shift register. The shift register can be loaded in series via the input TDI (test data in) or in parallel via the input pins E1 to En. Similarly, the output data can be taken in series at the output TDO (test data out) or in parallel at the outputs A1.1 to An. The testing of the connections between the outputs A1.1 to An of IC1 and the inputs E1 to En of device IC2 is shown in FIG. 1 as an example. For this purpose, a test bit pattern is pushed in series into the shift register via the input TDI of IC1, until it appears at the BSc output cells BScOUT of IC1. It is then transferred as a parallel bit pattern to IC2, transferred by the BSc input cells BScIN and pushed out in series via the shift register of IC2 at the output TDO, and then analyzed by the test system. The core logic is logically separated from the BSc register during this test.

FIG. 2 shows the principle of data transmission with differential lines. The transmitting device SB with the output driver stage AT sends signals that are complementary to one another at the pins A1.1 and A1.2, for example a logical “1” at A1.1 and a logical “0” at A1.2. The lines L1 and L2 are connected at the receiver device EB by a terminating resistor RT1 and RT2, respectively, to the terminating potential VTT, which is supplied by a voltage source UTT. Differential transmissions without the terminating potential are also possible, so that the resistors are connected in series and can be combined into one. In most of the CMOS technologies used today, the output stages (in the case of the transmitting device) are generally switched current sources and are consequently high-impedance. It may, however, be the case that (with no link to a terminating potential) possible common-mode interferences are poorly attenuated, so that the variant with terminating potential is usually used for high-speed data transmissions. Such a current source supplies, for example, the current J1 at the pin A1.1, which produces a corresponding voltage drop at RT1, and draws into the pin A1.2 a current J2, which produces a corresponding voltage drop at RT2. The input comparator K1 detects the voltage difference over RT1 and RT2. With a complementary level, the current directions are reversed. In the case of the LVDS (low voltage differential signaling) standard, described further below, J2=J1, so that the output stage is capable of acting as a source and as a sink. In the case of the CML (current mode logic) standard, also described below, the output stage is only capable of acting as a source or as a sink—depending on the way in which the circuitry is set up—and a current flows only in one line, while the other line is without current. The current then flows via the center tap C.

In the case of CMOS devices, processing of the logic signals takes place internally as simplex signals, i.e. each signal is assigned only one line, the level of which is related to a zero potential (frame). For the transmission from device to device, however, at high data rates differential signals are usually used. To avoid encumbering the input and output circuits (which receive and generate the differential signals) with the additional logic for the boundary scan (and consequently impairing the quality of the transmitted signals) during a boundary scan operation, the data is fed in at the transmission end as simplex signals upstream of the output driver. The data is similarly processed at the reception end as simplex signals downstream of the input buffer. This is shown in FIG. 3. BScOUT is the boundary scan cell upstream of the output driver, BScIN is the corresponding cell downstream of the input comparator. Consequently, it is not possible for both lines of a differential signal to be selected and evaluated separately at the transmitter end at the reception end, respectively. It is also not possible for both connection lines on the assembly to be tested independently of each other.

To be able to test both differential lines in the testing station, some additional test procedures have been used. For example, the lines concerned on the assembly were electrically bonded with needles, onto which currents were impressed, and the voltage drop was tested with the aid of additional pins on the transmitting and/or receiving device at the input protection diodes, input resistors, etc. However, such additional test procedures cause high costs. Moreover, bonding with needles presupposes that the lines are accessible on the surface of the assembly. In the new assembly technologies, however, μ vias are used, i.e. the plated-through holes (vias) between lines in different wiring planes are not drilled through the entire assembly, as in the past, but only between the planes in which these lines lie. Particularly, lines for high-bit-rate connections are then routed only in inner, shielded planes. Since, in the case of devices for high bit rates, ball-grid array packages, in which the terminals are soldered on the underside of the device and are no longer accessible, are used with preference, there is no longer any possible way of bonding these lines with needles.

If, in the case of a differential connection according to FIG. 2, one of the two lines is interrupted, for example by a hairline crack or by pins or balls that are not soldered on, this interruption cannot be clearly detected in the boundary scan. This is explained in more detail below on the basis of functional descriptions of LVDS and CML circuits.

For high-speed electrical data transmission between devices on an assembly or via a backplane onto another assembly, various interface standards have evolved, such as ECL (emitter coupled logic), GTL (gunning transceiver logic), CML, LVDS, etc. In these standards, the voltage levels or output currents, terminating resistors and the like are respectively standardized. The output circuits of the transmitting device often operate as switched current sources, which generate at the terminating resistors a corresponding voltage swing, which in the case of these standards is generally in the range of several hundred mV.

In the case of high data rates and CMOS, use is made in particular of LVDS (low voltage differential signaling) /2/ “IEEE Standard for Low-Voltage Differential Signals (LVDS) for Scalable Coherent Interface (SCI), IEEE Std 1596.3-1996, of Jul. 31, 1996, published by the IEEE Institute of Electrical and Electronics Engineers, Inc., New York”, and CML. FIG. 4 shows the functional mode of LVDS, FIG. 5 shows the functional mode of CML.

In the case of LVDS connections, the termination at the receiver takes place by means of a 100 Ω resistor between the differential lines. This resistor is often divided into two 50 Ω resistors connected in series, and the corresponding center terminal is connected to a fixed potential (in the case of LVDS 1.2 V), in order to attenuate common-mode interferences on the lines (FIG. 4). In modern CMOS technologies, the terminating resistors are generally integrated in the device. In the case of LVDS, when sending a logical “1”, current flows from the transmitter, from pin A1.1, through the resistors RT1 and RT2 back to the pin A1.2 of the transmitter. The receiver detects the voltage difference at the resistors and the input buffer converts it again into logic levels. When sending a logical “0”, the current direction is reversed, and consequently the algebraic sign of the voltage drop at RT1 and RT2 is inverted.

Let us now assume for explanatory purposes that the line L2 is interrupted, for example by a hairline crack on the assembly or by a pin that is not soldered on. Then, in the case of a logical “1”, the output current flows via RT1 to the voltage source UTT of 1.2 V. The same voltage drop as before occurs at RT1. There is no voltage drop at RT2. Although the input comparator now only receives half the swing at its input, it will correctly detect the “1”. In the case of a “0” at the transmitter output, the current direction is reversed and consequently the algebraic sign of the voltage drop at RT1 is inverted. RT2 is again without current. The “0” is correctly detected by the input comparator. Consequently, the interruption of one of the two differential lines cannot be detected downstream of the input comparator. The differential transmission is in this case reduced to a simplex transmission. At high data rates or clock frequencies, bit errors then occur because of the reduced reserve.

In the case of CML (FIG. 5), either one or the other line carries current, while the other is without current, depending on the logic transmitting level. At the inputs E1.1 and E1.2, the differential signal lines are connected to the terminating resistors RT1 and RT2. The other terminals are connected to a common terminating potential VTT. This terminating potential is often the supply voltage VDD of the device. A lower terminating potential may also be used, for example, to save power loss. In this case, the terminating potential is fed in from outside via a separate pin. Alternatively, it may be used to bring the input receiver to an optimum operating point. In this case, the terminating potential may either be generated in the device or be fed in from outside via a separate pin. When transmitting a logical “1”, transistor M1 is turned off and no voltage drop occurs at RT1. M2 is then turned on and takes over the current of the transistor M3 connected as the current source. The voltage drop at RT2 is detected by the input comparator and converted again into a logical “1”. When transmitting a logical “0”, M1 is turned on and takes over the current from the current source, so that a voltage drop occurs at RT1 and is detected by the input comparator. M2 is turned off, so that no voltage drop occurs at RT2.

Let us now assume, for example, that line L2 is again interrupted. In the case of a logical “1” at A1.1 and a “0” at A1.2, RT1 is without current. RT2 is also without current, since, although M2 is turned on, the current cannot flow through RT2 because of the interrupted line. The logic level at the output of the receiving comparator then depends on its offset voltage, i.e., depending on the algebraic sign of the latter, a “0” or “1” will occur at the output. If a “1” occurs, the “1” sent is correctly detected, in spite of the interrupted line. In the case of a “0” at the output A1.1, this is correctly detected at the receiver, since the current-carrying line is not interrupted. In the case of CML, whether a line interruption is detected consequently depends on the offset voltage of the input comparator.

### SUMMARY OF THE INVENTION

In one embodiment of the invention, there is an input circuit for the detection of an interruption in a differential signal feed. The circuit includes a pair of input terminals receiving differential data signals, and two inputs of a data comparator, connected to the input terminals, for generating data, wherein the two input terminals are connected to a respective comparator, the comparators have an auxiliary voltage applied on the input side, and signals at outputs of the comparators are evaluated such that an interruption of at least one of the signal feeds is detected.

In another aspect of the invention, the input circuit is arranged in an integrated circuit.

In another aspect of the invention, the input terminals are connected via a resistor to a terminating potential.

In yet another aspect of the invention, there is at least one current source, which is supplied to the auxiliary voltages at the resistors.

In another aspect of the invention, the auxiliary voltage is greater than the maximum input offset of the comparators and smaller than a minimum voltage swing of the data signal.

In another aspect of the invention, resistors are arranged in the integrated circuit.

In still another aspect of the invention, resistors are arranged outside the integrated circuit.

In another aspect of the invention, the input circuit having two current sources, each connected to the input terminal and to a supply potential, and each of the two current sources impresses a current which is lower than the currents flowing during normal operation or in a test case.

In another aspect of the invention, the outputs of the comparators are respectively connected to a boundary scan cell of a boundary scan shift register.

In yet another aspect of the invention, the input circuit is configured to be switched off.

In another embodiment of the invention, there is a method for detection of an interruption in a differential signal feed. The method includes, for example, feeding differential data signals to a pair of input terminals, and generating data at the two input terminals which are connected to the two inputs of a data comparator, wherein the two input terminals are connected to a comparator, the comparators have an auxiliary voltage applied on the input side, and the signals at the outputs of the comparators are evaluated such that an interruption of at least one of the signal feeds is detected.

### BRIEF DESCRIPTION OF THE DRAWINGS

The subject matter of the application is explained in more detail below in exemplary embodiments, on the basis of figures, in which:

FIG. 1 shows a basic representation of the boundary scan for two devices IC1 and IC2 in the prior art.

FIG. 2 shows the principle of a data transmission with differential lines in the prior art.

FIG. 3 shows a differential data transmission between CMOS devices with boundary scan in the prior art.

FIG. 4 shows an LVDS connection between CMOS devices in the prior art.

FIG. 5 shows a CML connection between CMOS devices in the prior art.

FIG. 6 shows an embodiment according to the present invention.

FIG. 7 shows another embodiment of the present invention.

FIG. 8 shows another embodiment of the present invention with terminating resistors outside the device.

FIG. 9 shows another embodiment of the present invention for LVDS technology.

FIG. 10 shows another embodiment of the present invention, in which current flows from the center tapping C through the terminating resistors.

FIG. 11 shows another embodiment of the present invention for CML technology.

FIG. 12 shows another embodiment of the present invention with terminating resistors outside the device.

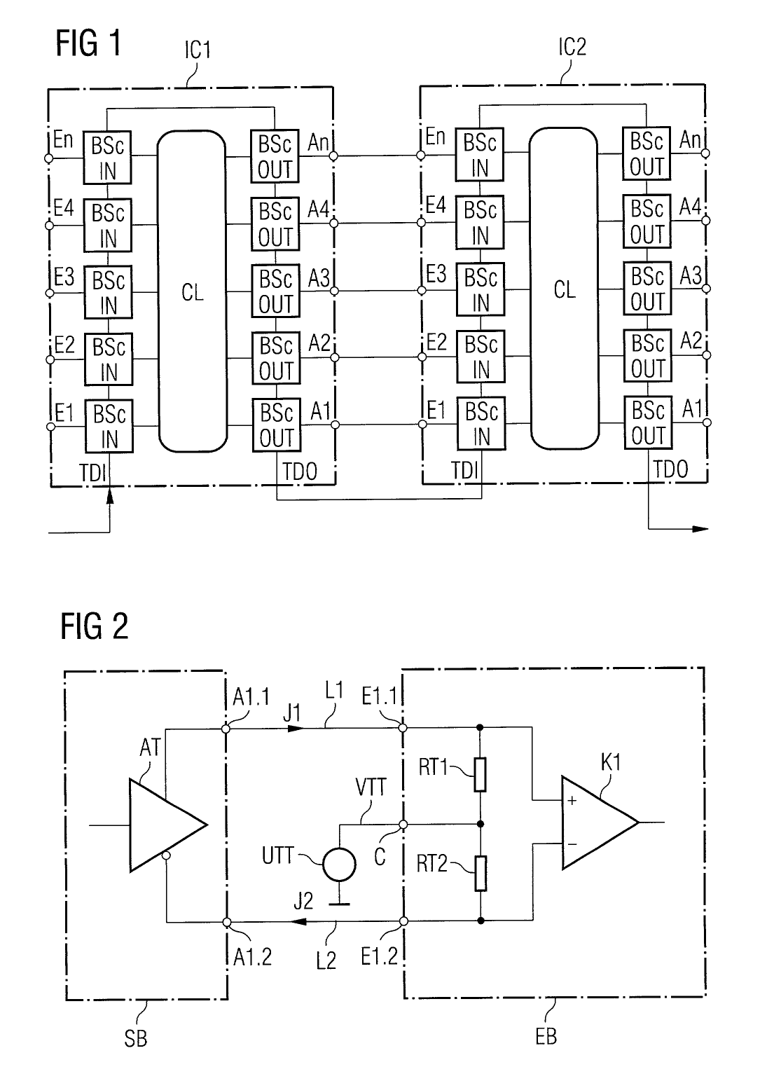

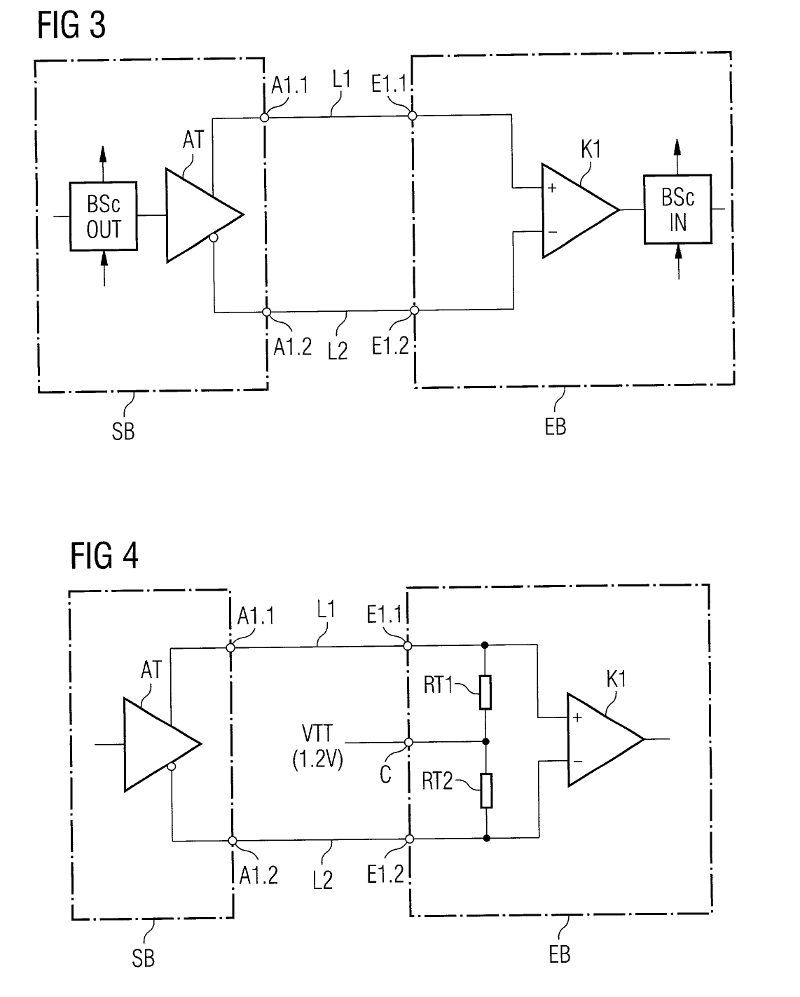

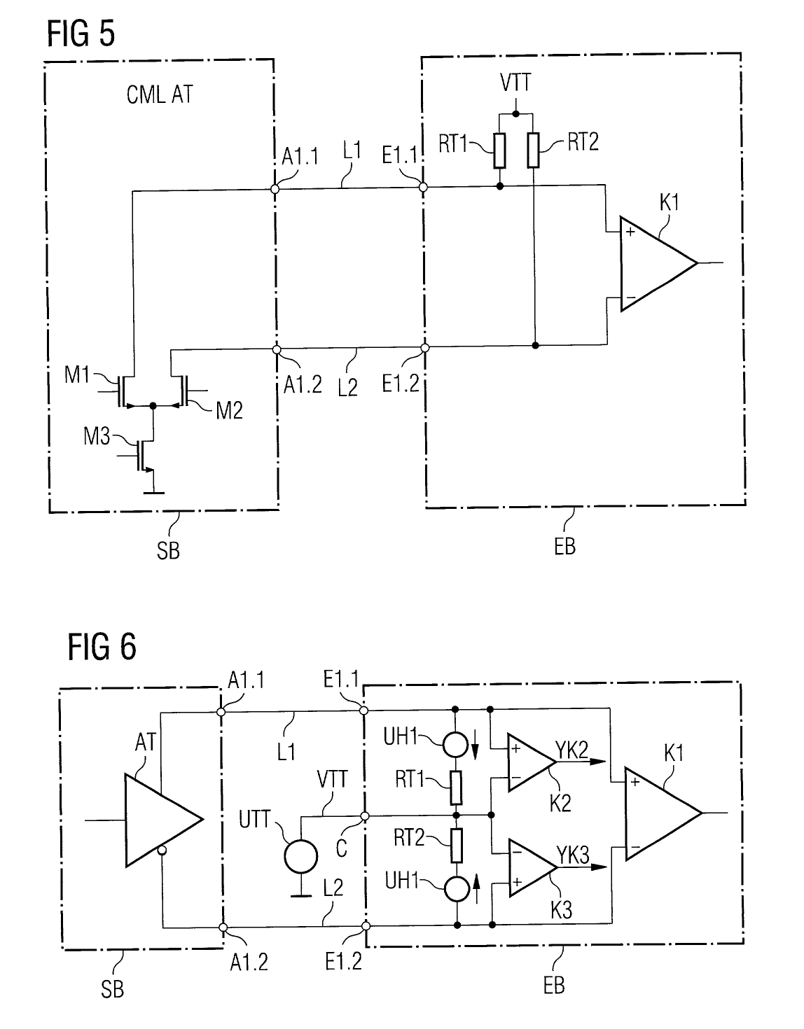

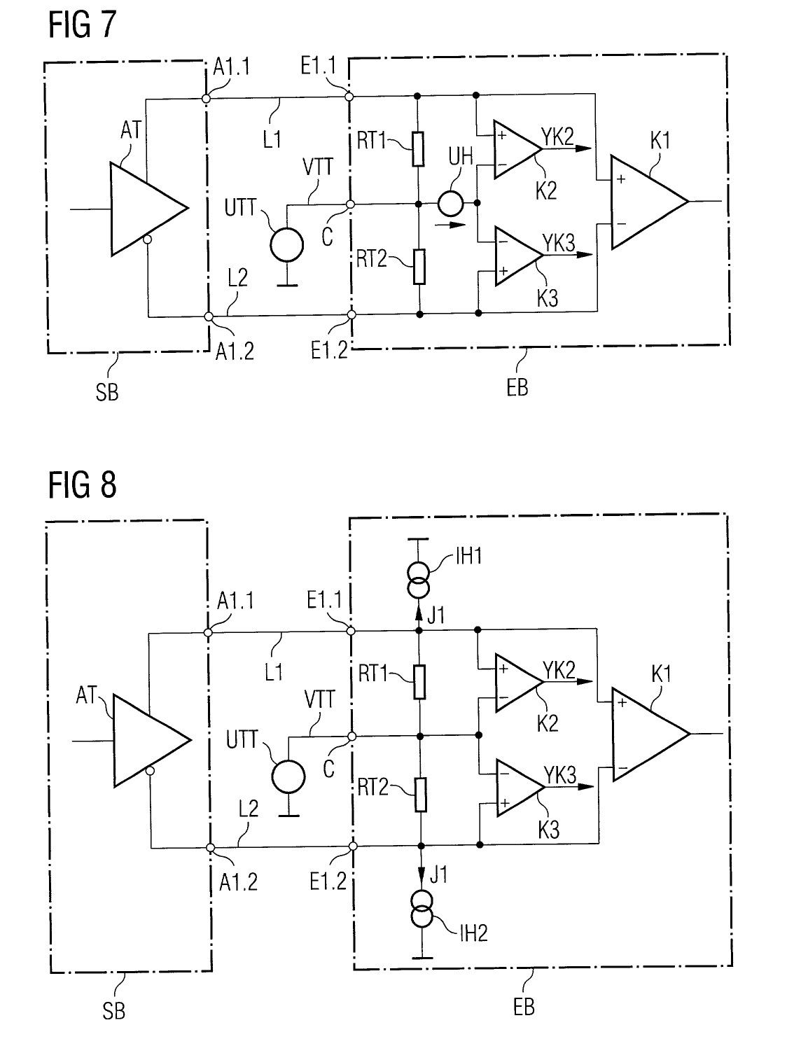

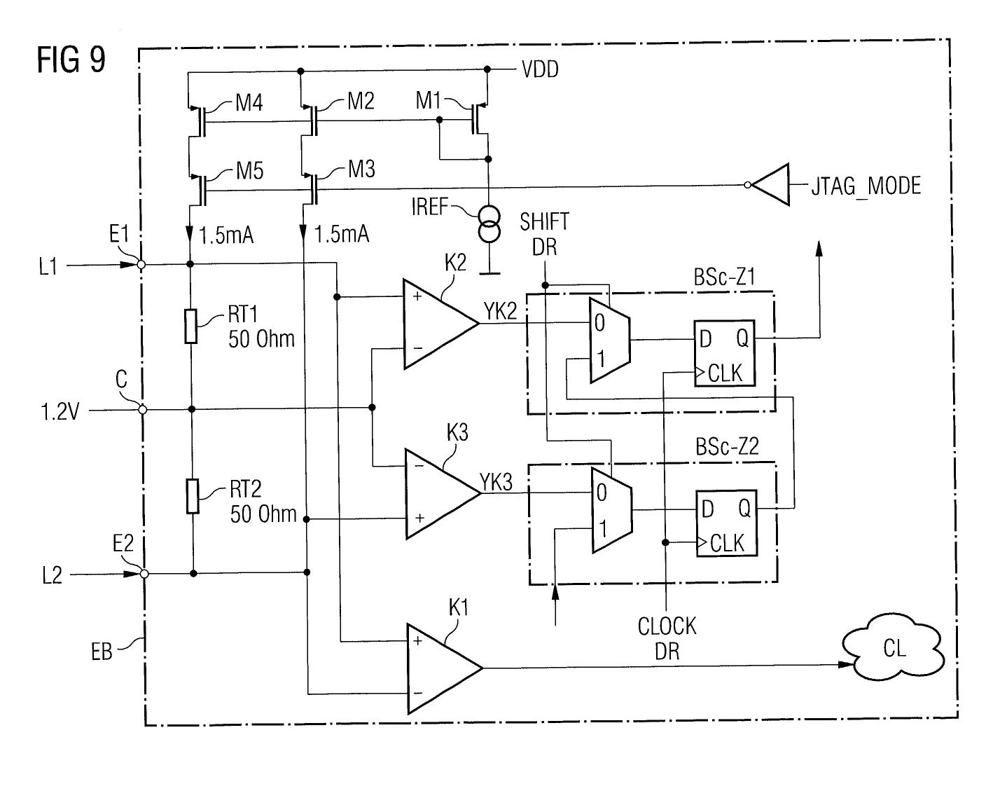

In the figures, the same designations denote the same elements.

### DETAILED DESCRIPTION OF THE PREFERRED EMBODIMENTS

The invention provides a way of making an interruption, even on one connection line, clearly detectable in the case of differential connections—for example on the basis of the LVDS principle with center tapping or on the basis of the CML principle.

The invention also discloses a clear detection of an interruption of one or both connection lines. Use of the circuit realizing the invention is preferably used for boundary scan operation. In the case of data transmission in normal operation, this supplementary circuit has no function and can be designed in such a way that it can be switched off, for example to save power loss.

According to one embodiment of the invention, the terminating resistors are arranged outside the device. There are two additional current sources, which are each connected by an input terminal and by the other terminal to a positive or negative supply potential. Alternatively, one of the two terminals is connected to a positive supply potential and the other is connected to a negative supply potential, each of the two current sources impressing a current which is significantly lower than the currents flowing in normal operation or in a test case.

This measure does not bring about any restriction in function, but prevents floating of the comparator inputs and associated undefined logic levels at the comparator outputs in the event of the interruption of one or both differential lines.

FIG. 6 shows an embodiment of the invention. In the receiving device EB there are at least two auxiliary voltage sources UH1 and UH2 and two comparators K2 and K3. The comparators K2 and K3 detect the voltage drop at RT1 and RT2 separately, so that the interruption of one (or else both) line(s) is detected. UH1 and UH2 prevent the input of K2 or K3 from floating, and consequently the output levels YK2 and YK3, respectively, from depending on the offset voltage of the comparators, when there is a line interruption. The auxiliary voltages, on the one hand, are greater than the maximum input offset of the comparators K2 and K3, so that a defined logic level occurs at the outputs of K2 and K3. On the other hand, however, they are smaller than the minimum voltage swing which the transmitter generates at a terminating resistor. In the rest state, i.e. when the transmitter is switched to high impedance, K2 and K3 respectively provide “1” at the output. Table 1 shows the respective possible combinations of transmission levels, intact or interrupted lines and corresponding output levels of the comparators K2 and K3. For the two auxiliary voltages, a value of ΔU=75 mV is assumed below for each. This lies safely above the offset for CMOS comparators and safely below the minimum swing at RT1 or RT2.

TABLE 1

| | | Transmission | | Reception | | | | |
|---|---|---|---|---|---|---|---|---|
| State of the | | data item at | | data item | | Comparator | | |
| lines | | the output | | at the input | | outputs | | |
| L1 | L2 | A1.1 | A1.2 | E1.1 | E1.2 | YK2 | YK3 | Remarks |
| intact | intact | 0 | 1 | 0 | 1 | 0 | 1 | |
| intact | intact | 1 | 0 | 1 | 0 | 1 | 0 | |
| inter- | intact | 0 | 1 | (ΔU) | 1 | 1 | 1 | Fault on |
| rupted | | | | * | | | | L1 |
| | | | | | | | | detected |
| inter- | intact | 1 | 0 | (ΔU) | 0 | 1 | 0 | |
| rupted | | | | * | | | | |
| intact | inter- | 0 | 1 | 0 | (ΔU) | 0 | 1 | |
| | rupted | | | | * | | | |
| intact | inter- | 1 | 0 | 0 | (ΔU) | 1 | 1 | Fault on |
| | rupted | | | | * | | | L2 |
| | | | | | | | | detected |
| inter- | inter- | 0 | 1 | (ΔU) | (ΔU) | 1 | 1 | Fault on |
| rupted | rupted | | | * | * | | | L1 |
| | | | | | | | | detected |
| inter- | inter- | 1 | 0 | (ΔU) | (ΔU) | 1 | 1 | Fault on |
| rupted | rupted | | | * | * | | | L2 |
| | | | | | | | | detected |

*(ΔU) is the value of the auxiliary voltages UH1 and UH2.

Table 1 reveals that, with the circuit according to the invention, interruptions of one or both differential lines are clearly detected, a logical “1” being present at each of both comparator outputs YK2 and YK3 when there is at least one line interruption.

FIG. 7 shows another embodiment according to the invention, which manages with one auxiliary voltage UH, which is then in series with the interconnected inputs of K2 and K3. In the case of CMOS, it is difficult to set up circuitry for such auxiliary voltage sources. By contrast, current sources can be set up well, so that an auxiliary voltage is expediently generated by means of a current source and a resistor. Since the terminating resistors are already present, they can be advantageously used for this purpose. FIG. 8 shows one possible way of realizing this. There are two current sources, which impress through the terminating resistors (here assumed to be of the same size) currents J1 with respect to the negative supply potential or frame, whereby the auxiliary voltages are produced directly at these resistors. Current sources which are connected to a positive supply potential and impress currents J1 in the reverse direction, so that the algebraic sign of the auxiliary voltages is inverted, can also be used. Similarly, one current source can impress a positive current onto one terminating resistor, the other a negative current onto the other terminating resistor. If appropriate, the inverting input and non-inverting input are then to be correspondingly changed over for comparator K2 and K3, respectively.

In the examples above, the terminating resistors were integrated in the device. However, the circuit according to the invention is not restricted to this, but can also be used when the terminating resistors are located outside the device. By analogy with FIG. 8, when there is an interruption between the external resistor and the input circuit, for example because of a pin that is not soldered on, the inputs of the comparators K2 and K3 are then pulled by the current sources to a defined potential and floating of the inputs is prevented.

Exemplary embodiments of the supplementary circuit according to the invention are given below in the case of LVDS and CML.

An exemplary embodiment of the supplementary circuit according to the invention for the LVDS case is shown in FIG. 9. At the inputs E1.1 and E1.2 there are the terminating resistors RT1 and RT2, the other terminals of which are interconnected and connected via pin C to the external 1.2 V voltage source. The comparator K1 is the LVDS input comparator. The comparators K2 and K3, the transistors M1 to M5 and the current source IREF form the exemplary circuit for the boundary scan case. Furthermore, there are two boundary scan cells BSc-Z1 and BSc-Z2, which belong to the normal boundary scan register. In the boundary scan case, the current is mirrored via the transistor M1 onto M2 and M4 from the current source IREF, which generates a reference current. M1, M2 and M4 form a current mirror. The mode of operation of a current mirror and the generation of a reference current are explained variously in the literature, for example /3/ “Paul R. Gray, Robert G. Meyer, “Analysis and Design of Analog Integrated Circuits”, John Wiley & Sons, New York, 1984”. The current flow through M2 and M4 is intended to be about 1.5 mA in each case, so that a voltage drop of about 75 mV respectively occurs at RT1 and RT2 (1.5 mA * 50 Ω=75 mV). This can be achieved by the size of IREF and corresponding dimensioning of M1, M2 and M4. In another embodiment, the auxiliary voltages at RT1 and RT2 are generated by current sources which pull a current from the terminal C to GND, as already represented in principle in FIG. 8.

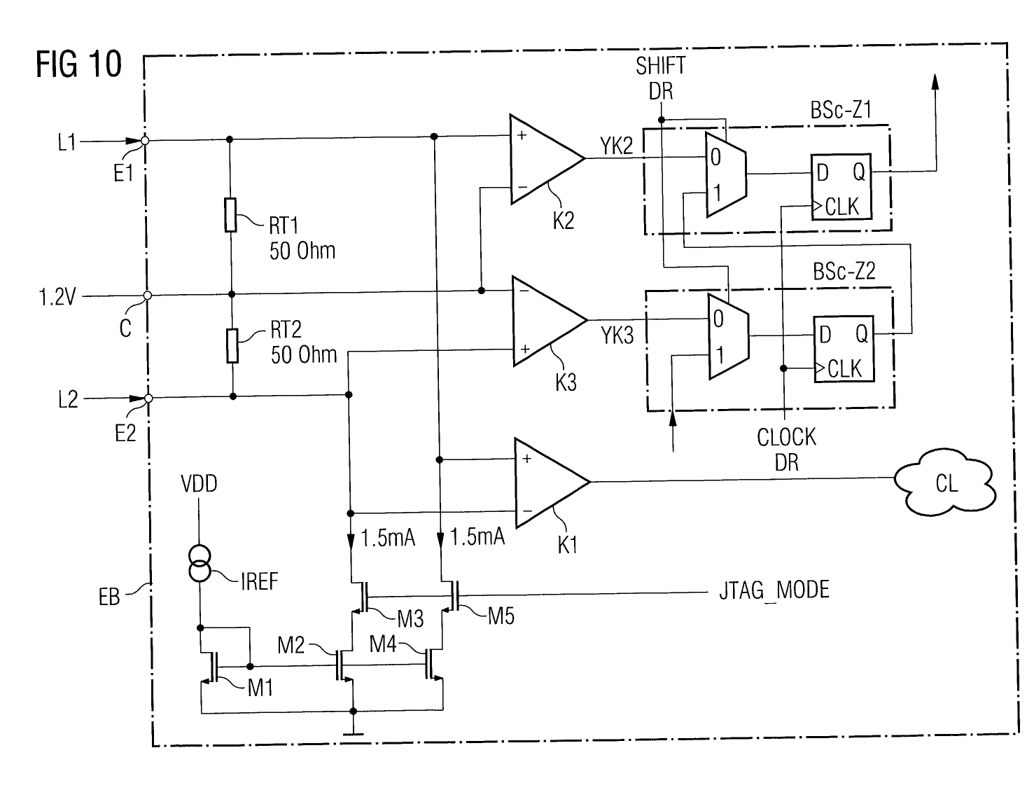

FIG. 10 shows a circuit according to the invention. Then, n-channel transistors have to be correspondingly used instead of p-channel transistors. As a result, however, the current directions are reversed, and the function remains the same. It should further be noted that, because of the reversed current directions, in the event of a line interruption the corresponding output signal YK2 or YK3 is in this case reversed in comparison with table 1, such that there is a fault if both outputs provide a logical “0”. The signal JTAG_MODE in FIGS. 9 and 10 is to be provided by the TAP controller, which is a component part of the boundary scan logic /1/. In the boundary scan case, this signal is intended to be logical “1”, so that M4 and M5 are turned on and the exemplary circuit is activated. In normal operation, JTAG_MODE is logical “0” and the transistors M4 and M5 are then consequently turned off. To save power loss, the comparators K2 and K3 and the current source IREF may also be switched off in normal operation. M4 and M5 and K2 and K3 can be dimensioned with small transistor widths, so that the additional capacitance at the inputs remains small compared with the overall capacitance of the package, pads, input-protection-diode protective structures and comparator K1, so that the cut-off frequency is not appreciably reduced. Table 1 likewise applies to the LVDS case.

If the terminating resistors are located outside the device, the current sources with M2 to M5 prevent the inputs of the comparators K2 and K3, which are connected to E1.1 and E1.2, respectively, from floating if there is an interruption between the external terminating resistor and the input circuit, for example because of a pin E1.1 or E1.2 that is not soldered on. If it is necessary that, when there is an interruption of both lines, comparator K1 also emits a defined level to the core logic, it can be detected by an additional monitoring circuit that both inputs are at negative or positive supply voltage—depending on the polarity of the current sources—and, as a consequence, that a defined level is passed on. This corresponds to the prior art and is not explained any further.

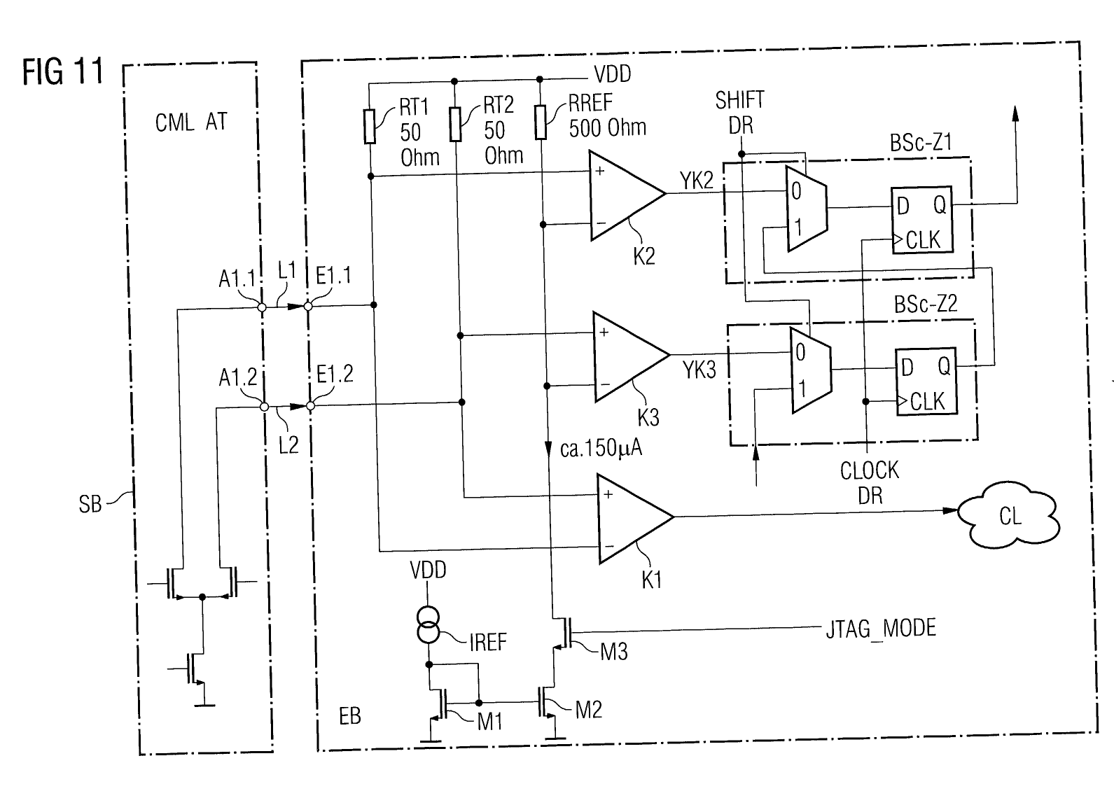

An exemplary embodiment of the circuit according to the invention for the CML case is shown in FIG. 11. It corresponds to the embodiment from FIG. 7. The comparator K1 is the CML input comparator. The comparators K2 and K3, the transistors M1, M2 and M3, the reference current source IREF and an additional reference resistor RREF form the circuit for the boundary scan case. Furthermore, there are two boundary scan cells BScZ1 and BScZ2, which belong to the normal boundary scan register. In normal operation, the signal JTAG_MODE is logical “0”; consequently, M3 is turned off.

In the boundary scan case, JTAG_MODE is logical “1” and the current is mirrored via the transistor M1 onto M2 from the current source IREF. The current flow through M2 and M3 is chosen such that a voltage drop of approximately 75 mV occurs at RREF, that is to say for example J(M2)=150 μA and RREF=500 Ω. The same as already described above applies for the voltage drop and the measures for saving power loss. Table 2 shows the respective possible combinations of transmission levels, intact or interrupted lines and corresponding output levels of the comparators K2 and K3. The logical function corresponds to that of table 1, however, the height of the levels in columns E1.1 and E1.2 is different.

TABLE 2

| | | Transmission | | Reception | | | | |
|---|---|---|---|---|---|---|---|---|
| State of the | | data item at | | data item | | Comparator | | |
| lines | | the output | | at the input | | outputs | | |
| L1 | L2 | A1.1 | A1.2 | E1.1 | E1.2 | YK2 | YK3 | Remarks |
| intact | intact | 0 | 1 | 0 | 1 | 0 | 1 | |
| intact | intact | 1 | 0 | 1 | 0 | 1 | 0 | |
| inter- | intact | 0 | 1 | 1 | 1 | 1 | 1 | Fault on |
| rupted | | | | | | | | L1 |
| | | | | | | | | detected |
| inter- | intact | 1 | 0 | 1 | 0 | 1 | 0 | |
| rupted | | | | | | | | |
| intact | inter- | 0 | 1 | 0 | 1 | 0 | 1 | |
| | rupted | | | | | | | |
| intact | inter- | 1 | 0 | 1 | 1 | 1 | 1 | Fault on |
| | rupted | | | | | | | L2 |
| | | | | | | | | detected |
| inter- | inter- | 0 | 1 | 1 | 1 | 1 | 1 | Fault on |
| rupted | rupted | | | | | | | L1 |
| | | | | | | | | detected |
| inter- | inter- | 1 | 0 | 1 | 1 | 1 | 1 | Fault on |
| rupted | rupted | | | | | | | L2 |
| | | | | | | | | detected |

Table 2 reveals that, with the circuit according to the invention, interruptions of one or both differential lines are clearly detected for the CML case too, a logical “1” being present at each of both comparator outputs YK2 and YK3 when there is at least one line interruption.

If the terminating resistors RT1, RT2 are located outside the device, in the event of an interruption at E1.1 or E1.2 the non-inverting input of comparator K2 or K3 is floating if there is an interruption between the external terminating resistor and the input circuit, for example because of a pin E1.1 or E1.2 that is not soldered on.

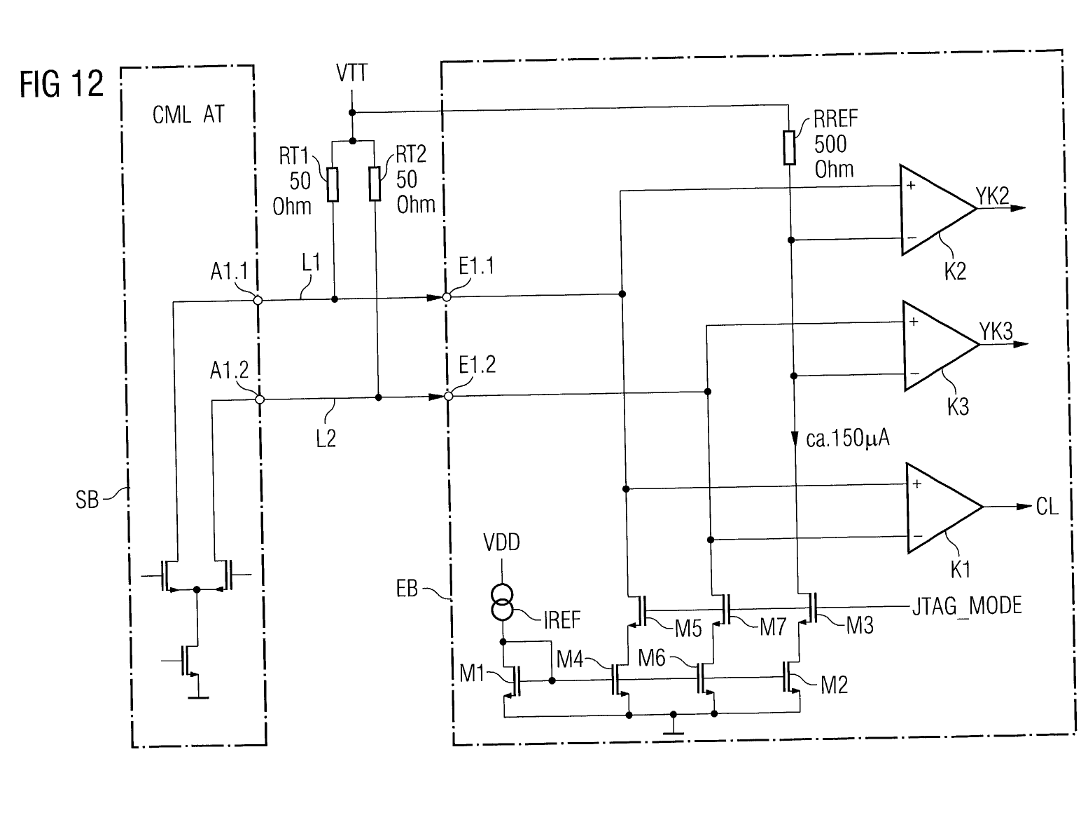

FIG. 12 shows a circuit extension with the transistors M4 to M7, which prevents this. M4 to M7 form two additional current sources, which are to be dimensioned such that they generate a small current of a few μA, so that, although floating of the comparator inputs is avoided for the case in which there is an interruption, the function is not influenced. Because of the small current, the turn-off transistors M5 and M7 can be dimensioned to be very small, so that in normal operation a minimal capacitance is effective at the input, which insignificantly influences the transmission speed.

According to one embodiment of the invention, an auxiliary voltage in relation to the terminating potential can be generated by a current source which is connected to one end of a resistor and the other end of which lies at the terminating potential, this auxiliary voltage being passed to the interconnected inverting (or non-inverting) inputs of the two comparators, while the respective non-inverting (or inverting) input of a comparator is connected to the input line assigned to it.

According to another embodiment of the invention, the current sources are set up with n-channel transistors (in the case of CMOS technology) or npn transistors (in the case of bipolar technology), a current flow from the terminating potential to the negative supply potential (frame or ground) being brought about at each of the terminating resistors.

According to still another embodiment of the invention, the current source is set up with p-channel transistors (in the case of CMOS technology) or pnp transistors (in the case of bipolar technology), a current flow from the positive supply potential to the terminating potential being brought about at each of the terminating resistors.

What is claimed is:

1. An input circuit for the detection of an interruption in a differential signal feed, comprising:
a pair of input terminals receiving differential data signals; and
two inputs of a data comparator, connected to the input terminals, to generate data, wherein
the two input terminals are connected to respective comparators,
the comparators have an auxiliary voltage applied on the input side, and
signals at outputs of the comparators are evaluated such that an interruption of at least one of the signal feeds is detected.

2. The input circuit as claimed in claim 1, wherein the input circuit is arranged in an integrated circuit.

3. The input circuit as claimed in claim 1, wherein the input terminals are connected via a resistor to a terminating potential.

4. The input circuit as claimed in claim 3, wherein there is at least one current source which is supplied to the auxiliary voltages at the resistors.

5. The input circuit as claimed in claim 1, wherein the auxiliary voltage is greater than the maximum input offset of the comparators and smaller than a minimum voltage swing of the data signal.

6. The input circuit as claimed in claim 2, wherein resistors are arranged in the integrated circuit.

7. The input circuit as claimed in claim 2, wherein resistors are arranged outside the integrated circuit.

8. The input circuit as claimed in claim 7, the input circuit having two current sources, each connected to one of the input terminals and to a supply potential, and each of the two current sources impresses a current which is lower than the currents flowing during normal operation or in a test case.

9. The input circuit as claimed in claim 1, wherein the outputs of the comparators are respectively connected to a boundary scan cell of a boundary scan shift register.

10. The input circuit as claimed in claim 1, wherein the input circuit is configured to be switched off.

11. A method for detection of an interruption in a differential signal feed, comprising:
feeding differential data signals to a pair of input terminals; and
generating data at the pair of input terminals which are connected to two inputs of a data comparator, wherein
the pair of input terminals are connected to a comparator,
the comparators have an auxiliary voltage applied on the input side, and
the signals at the outputs of the comparators are evaluated such that an interruption of at least one of the signal feeds is detected.
